(19) United States
(12) Patent Application Publication
(10) Pub. No.: US 2004/0240688 A1
(43) Pub. Date: Dec. 2, 2004

(54) Loudspeaking structure applied on a portable computer

(76) Inventors: Hsin-Yuan Chiang, LuChou City (TW); Po-Hsiung Yu, SanChung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/446,081

(22) Filed: May 28, 2003

(51) Int. Cl. H04R 5/02; H04R 1/02; H04R 9/06

(52) U.S. Cl. 381/306; 381/333; 381/388

(57) ABSTRACT

The present invention offers a loudspeaking structure applied on a portable computer, the loudspeaking structure comprises a fixing frame, a casing and a base; a top surface of the fixing frame has a plurality of containing speaker sections for enclosing speakers, the containing speaker sections further provide a plurality of sound-guide holes. By way of the present invention, the condition of a smaller resonance space of the loudspeaking structure in prior arts is no longer exist, instead of the prior art is a bigger resonance room. Therefore, the amplifying efficient of the prior speaker of the portable computer is highly promoted.

### BACKGROUND OF THE INVENTION

1. Field of the Invention

The present invention generally relates to a loudspeaking structure applied on a portable computer, especially to the loudspeaking structure which increasing resonance space of a loudspeaking member, and thus sound quality, high-pitched and low pitched voices from the loudspeaking structure being promoted.

2. Description of the Prior Art

The current portable computer includes notebook computer, tablet computer, etc. Please refer to FIG. 1, which is an explored view of a portable computer frame structure in prior arts. The frame structure is composed by a fixing frame 16′, a casing 12′ and a base 18′; the casing 12′ covers the fixing frame 16′, and the fixing frame 16′ is on the base 18′ and mainly contains a motherboard 17′ and other components (not shown in the Figure).

The loudspeaking structure in prior portable computer mainly adopts two speakers 10′ positioned in the casing 12′, which also having a plurality of sound holes 14′ for sound from the two speakers 10′ spreading out to outside.

To design a structure of a loudspeaking structure is mostly to improve a whole efficiency and timbre, hence a structure design is depended on that how a computer is designed to work. For example, a general portable computer must be light and thin, therefore a speaker shall be formed as a thin and flat figure, but some functions of the speaker will be sacrificed due to small resonance space. Please refer to FIG. 2, which is a sketch of relative positions of a loudspeaker, a casing and a fixing frame in prior arts. As usual, the speaker 10′ is fastened by two screws 11′ on the casing 12 and has a plurality of holes 100′, which are located on a lower part of the speaker 10′ corresponding to an upper part of the fixing frame 16′. Due to the holes 100′ being adjacent to the fixing frame 16′, sound from the speaker 10′ spreading through the holes 100′ is blocked by the fixing frame 16′ to cause a worse efficiency of the speaker 10′, and hence how to design a loudspeaking structure for improving speaker efficiency is an important issue.

### SUMMARY OF THE INVENTION

The main objective of the present invention is to offer a loudspeaking structure applied on a portable computer for improving an efficiency of speakers of a prior portable computer. By means of the loudspeaking structure, a bigger resonance space is acquired and better to improve the sound efficiency of the portable computer.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is an explored view of a portable computer frame structure in prior arts.

FIG. 2 is a sketch of relative positions of a loudspeaker, a casing and a fixing frame in prior arts.

FIG. 3 is an explored view of a portable computer body of a preferred embodiment of the present invention.

FIG. 4 is a sectional view of a structure of the preferred embodiment of the present invention.

FIG. 5, which is a detail perspective sketch of relative positions of the casing, the speaker and the fixing frame of the present invention.

FIG. 6 is a sketch of the speaker of the present invention.

FIG. 7 is a sketch of the containing speaker section of the present invention.

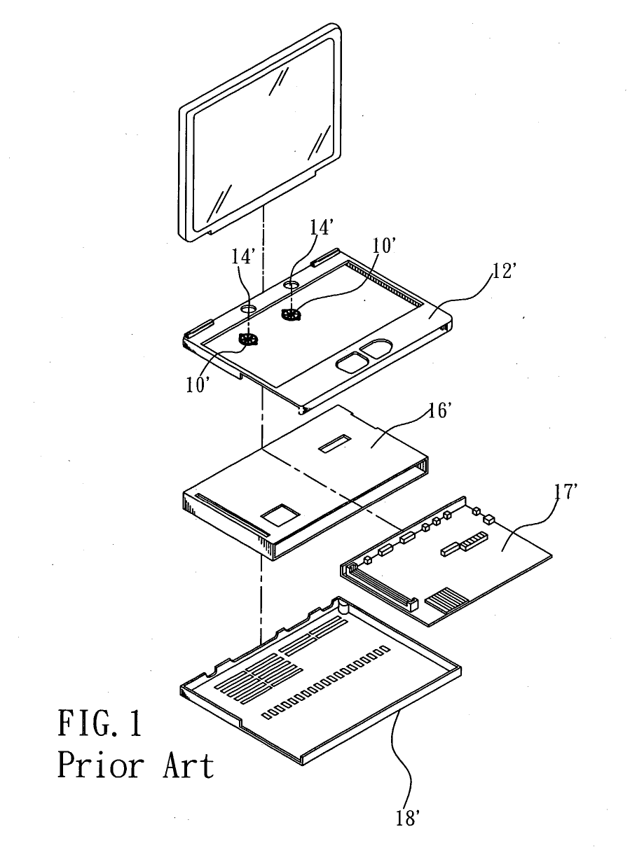

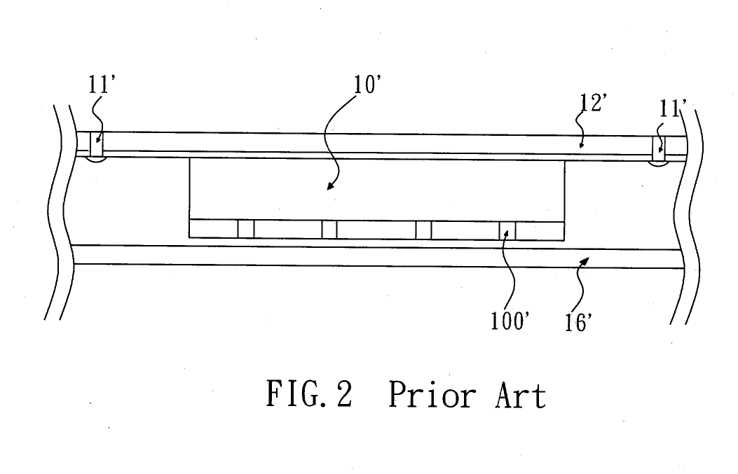

### DETAILED DESCRIPTION OF THE INVENTION

The present invention is applied on the field of portable computer to get better efficiency of a loudspeaking device in prior arts. The field of portable computer comprises notebook computer, palm computer, tablet computer, desktop portable computer, etc., and it is known that the application scope being very wide and to promote the quality of audio and video.

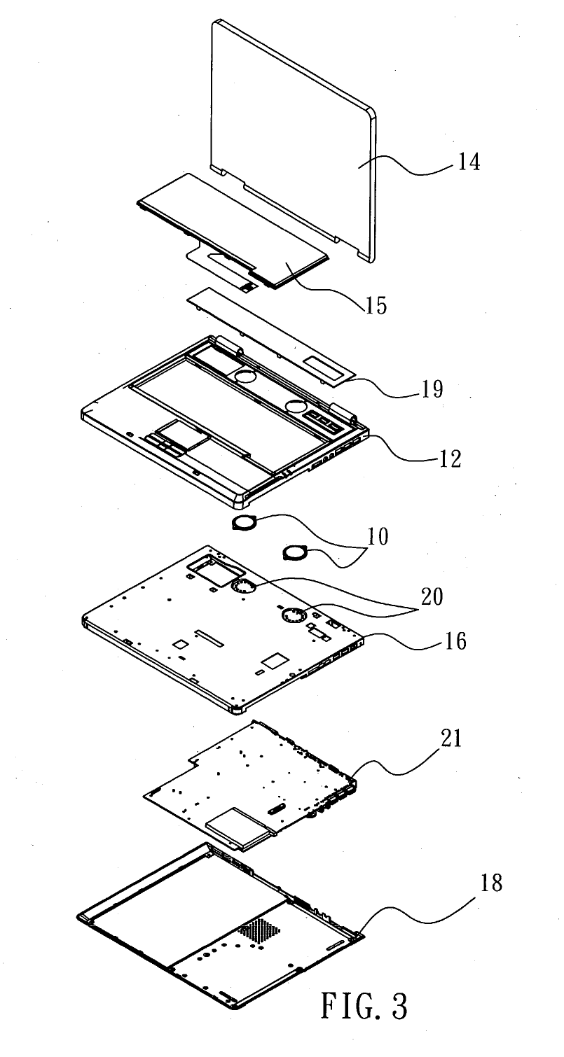

Please refer to FIG. 3, which is an explored view of a portable computer body of a preferred embodiment of the present invention. The FIG. 3 shows that the portable computer body mainly comprises a panel 14, a keyboard 15, a cover plate 19, a casing 12, two speaker 10, a fixing frame 16, a fixing component plate 21 and a base 18; further, two containing speaker sections 20 slightly intaglioed into the fixing frame 16 are to enclose two speakers 10. The present invention focuses on discussing the technical part and relative positions of the casing 12, the speakers 10, the containing speaker sections 20, the fixing frame 16 and the base 18.

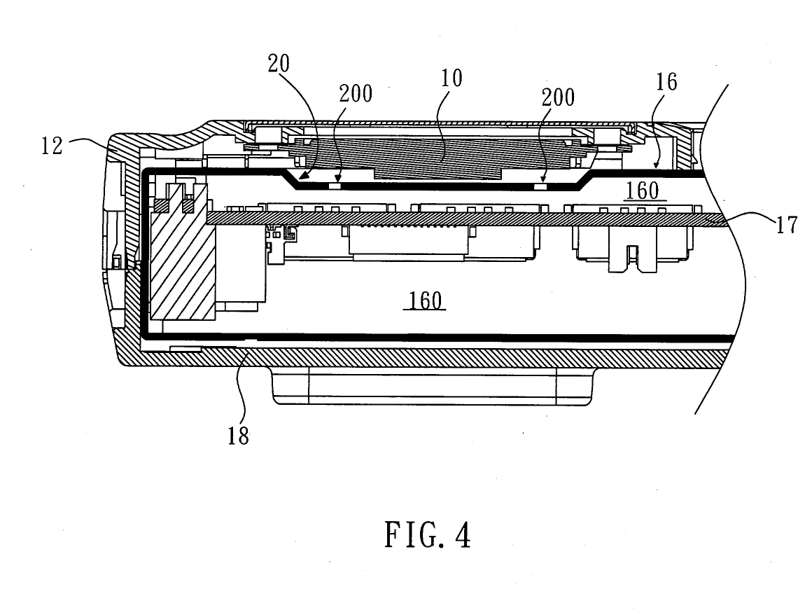

Please refer to FIG. 4, which is a sectional view of a structure of the preferred embodiment of the present invention. As showing from FIG. 4, the present invention is constructed by the casing 12, the base 18 and the fixing frame 16. The casing 12 and the base 18 together compose an external structure of the present invention. The fixing frame 16 is embedded in a room structured by the casing 12 and the base 18 and further to form another smaller internal room 160. Partial upper frame of the fixing frame 16 is sunken, where is the containing speaker section 20. The current structure is designed to fit with the purposes of light and thin formation. The speaker 10 is fastened on an internal surface of the casing 12 and just below the containing speaker section 20. It is not necessary that the speaker 10 being fixed on the internal surface of the casing 12, another option is that the speaker 10 being on the fixing frame 16. The containing speaker section 20 has two sound-guide holes 200 for sound from the speaker 10 spreading into the internal room 160 via the two sound-guide holes 200. An important point is that FIG. 4 is a sectional view to only show two sound-guide holes 200, and it will not only show two sound-guide holes 200 in case of a perspective drawing. The relationship of the sound-guide hole 200 and the containing speaker section 20 will be discussed later. By means of the internal room 160, a resonance space is specific for reechoing sound; the efficiency of the speaker is been completely brought into full play. On the other hand, the internal room 160 functions to contain a motherboard 17 and other components. As aforesaid, the internal room 160 is the loudspeaking structure of the present invention and also offers the functions of containing electrical components and reserving sound for generating a resonance space and amplifying sound. A special point is that the motherboard 17 and the sound-guide holes 200 of the fixing frame 16 may keep a suitable distance, therefore the sound from the speaker 10 is capable of spreading into the internal room 160 of the fixing frame 16 via the sound-guide holes 200.

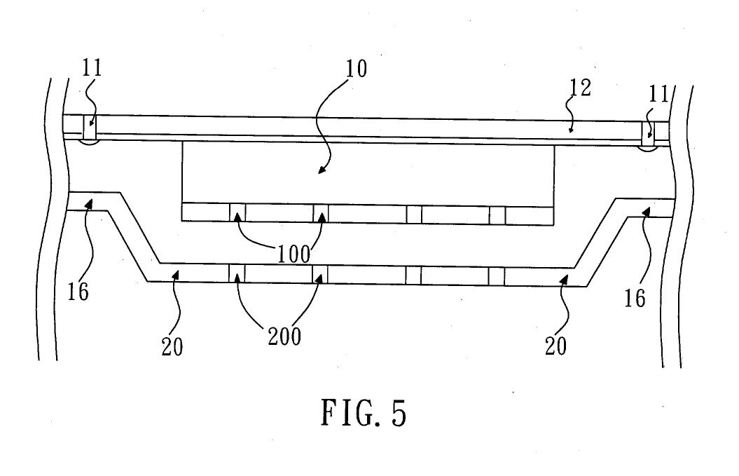

Please refer to FIG. 5, which is a detail perspective sketch of relative positions of the casing, the speaker and the fixing frame of the present invention. The casing 12 and the speaker 10 are fastened together by means of two screws 11. A bottom of the speaker 10 has a plurality of holes 100. The positions of the sound-guide holes 200 are corresponding to the locations of the holes 100. Hence, as afore mention, while sound spreading from the speaker 10, there is immediately a channel, the plural holes 100 and the plural sound-guide holes 200, for the sound passing through to the internal room 160.

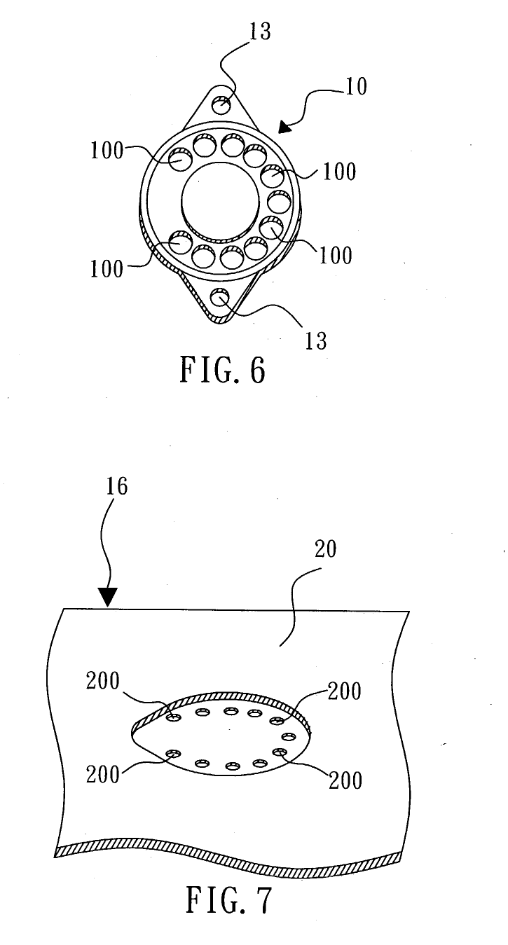

Please refer to FIG. 6, which is a sketch of the speaker of the present invention. The FIG. looks from up to down with an angle. Plural holes 100 are arranged on the speaker 10 in circle for sound spreading. Further, two fastening holes 13 provide to fix the speaker 10 on the casing 12.

Please refer to FIG. 7, which is a sketch of the containing speaker section of the present invention. The FIG. looks from up to down with an angle. Plural sound-guide holes 200 are arranged on the containing speaker section 20 in circle, and the positions of the sound-guide holes 200 are corresponding to the locations of the holes 100. That is for what sound directly gets into the internal room 160 by means of the sound-guide holes 200 while the sound spreading through the holes 100, and then the amplifier purpose is approached because the internal room 160 play the function of resonance.

As a conclusion, the present invention has the following characteristics:

1. By way of executing the present invention, the resonance space is enlarged, and a space of the fixing frame is fully used as a resonance room of the speakers.

2. By way of executing the present invention, sound quality, high-pitched and low-pitched voices, etc., are promoted.

3. The present invention is suitable to the current requests of light and thin for portable computer, which including notebook computer, tablet computer, portable desktop computer, etc.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A loudspeaking structure applied on a portable computer comprises:
a casing;
a base, which cooperating with the casing to compose an external portion of the loudspeaking structure;
a fixing frame, which embedding in the casing and cooperating with the base to form an internal portion, a surface of the fixing frame adjacent to the casing having at least one containing speaker section, and the fixing frame forming an internal room thereof.

2. The loudspeaking structure applied on the portable computer as cited in claim 1, wherein between a surface of the casing and the surface of the fixing frame further provides at least one speaker, which is contained in the containing speaker section.

3. The loudspeaking structure applied on the portable computer as cited in claim 2, wherein adjacent portions of the speaker and the containing speaker section provide at least one hole and at least one sound-guide hole, locations of the hole and the sound-guide hole are corresponding to each other.

4. The loudspeaking structure applied on the portable computer as cited in claim 1, wherein the internal room encloses at least one motherboard and other components.

5. The loudspeaking structure applied on the portable computer as cited in claim 4, wherein a suitable distance is provided between the motherboard and the fixing frame.

6. The loudspeaking structure applied on the portable computer as cited in claim 1, wherein the portable computer is one of the following: notebook computer, palm computer, tablet computer and portable desktop computer.
